(19) United States
(12) Patent Application Publication
(10) Pub. No.: US 2015/0219014 A1
(43) Pub. Date: Aug. 6, 2015

(54) DEVICE FOR THE TRANSFER OF HEAT BETWEEN A LUBRICATION PIPE AND A TURBOMACHINE BLADE PITCH ACTUATOR CONTROL HYDRAULIC PIPE

(71) Applicant: SNECMA, Paris (FR)

(72) Inventors: Olivier Belmonte, Perthes en Gatinais (FR); Augustin Curlier, Melun (FR)

(73) Assignee: SNECMA, Paris (FR)

(21) Appl. No.: 14/414,343

(22) PCT Filed: Jul. 18, 2013
(86) PCT No.: PCT/FR2013/051732

§ 371 Date: Feb. 12, 2015

(30) Foreign Application Priority Data
Jul. 20, 2012 (FR) 12 57075

(51) Int. Cl. F02C 7/24; F02C 9/16; F02C 7/06; F02C 3/10; F02C 3/067

(52) U.S. Cl. CPC F02C 7/24; F02C 3/10; F02C 3/067; F02C 7/06; F02C 9/16; F05D 2300/172; F05D 2270/20; F05D 2270/64; F05D 2210/12; F05D 2220/323; F05D 2260/2214

(57) ABSTRACT

An aircraft turbomachine including a lubricant circulation pipe and a hydraulic pipe for controlling an actuator for changing a pitch of blades of a propeller of the turbomachine. The assembly, integrated to a receiver of the turbomachine, further includes a mechanism forming a thermal bridge between the lubricant circulation pipe and the hydraulic pipe.

### TECHNICAL FIELD

The invention relates to the field of cooling hydraulic pipes for controlling actuators for changing the pitch of the blades of a turbomachine propeller.

This more preferably entails a turbomachine receiver propeller, for example a system of contra-rotating propellers, such as a contra-rotating propeller dipole of a turbomachine with unducted fan. This type of turbomachine is for example known in document FR 2 942 203.

Nevertheless, the invention could apply to the controlling in incidence of propeller blades of another type, for example those of a propeller of a conventional turboprop engine.

### PRIOR ART

On certain turbomachines, the receiver with unducted contra-rotating propeller dipole is located in the rear continuity of the gas generator, namely in a very hot environment. This receiver generally includes an exhaust casing of the turbomachine, of which the arms that pass through the flow stream allow for the passage of varied elements such as hydraulic pipes for controlling actuators for changing the pitch of the blades of one and/or the other of the two propellers.

Through these hydraulic pipes, the fluid is considered as relatively static, as it is not constantly necessary to have it flow through these pipes, since the incidence of the blades is not constantly modified.

The relatively static nature and the exposure to the heat of the fluid result in a substantial risk of coking, able to reduce and even close off the supply sections required for the proper operation of the turbomachine. This risk all the more so high when the environment of the hydraulic pipes is hot, which is particularly the case when the latter transit through the arms of the exhaust casing heated by its position at the output of the gas generator, with these pipes being indeed in this case subjected to the heat radiation of the casing.

It can therefore, in certain circumstances such as those described hereinabove, be required to provide a cooling of these hydraulic pipes, in order to avoid the problem mentioned hereinabove. However, the conventional solutions for carrying out such a cooling appear to be poorly suited to an environment that is already dense, and are moreover particularly expensive.

### SUMMARY OF THE INVENTION

The invention therefore has for purpose to overcome at least partially the disadvantages mentioned hereinabove, concerning the achievements of prior art.

To do this, the invention has for object a receiver for aircraft turbomachine according to claim 1. The invention provides an original, simple, effective and inexpensive solution to the problem encountered in prior art. Indeed, the principle according to the invention breaks with the conventional technologies of exchanging heat by planning to use an existing servitude, here the adjacent lubricant pipe, in order to evacuate the heat that build up in the hydraulic pipe for controlling an actuator. The means forming a thermal bridge arranged between two pipes thus serve to transfer the heat from one pipe to the other, with this heat then being evacuated by the lubricant flowing usually with a substantial flow rate in its pipe, contrary to the fluid of the hydraulic pipe for controlling an actuator which is relatively static.

As such, thanks to the simple adding of means forming a thermal bridge proper to the invention, the hydraulic pipe for controlling an actuator is no longer subjected to the risk of coking, even when it is placed in a hot environment.

More precisely, the hydraulic pipe for controlling an actuator is substantially protected from the risks linked to the heat given off by the casing that it passes through, with this radiant heat able to be very high in particular when it entails an exhaust casing located behind the gas generator.

Preferably, said means forming a thermal bridge comprise a plurality of strips each having two ends respectively connected to said lubricant circulation pipe and to said hydraulic pipe. More generally, these means can take any form of solid means directly connected to each of the two pipes.

Preferably, said means forming a thermal bridge are made of copper or of one of its alloys. This type of material favours thermal conduction, and as such improves the thermal dissipation effect through the lubricant pipe. Any other material having a high capacity to conduct the heat can be considered, without leaving the scope of the invention.

Preferably, a thermal protection sheath is provided that covers the assembly formed by the means forming a thermal bridge and the portions of the pipes connected by these same means. This protection advantageously makes it possible to limit the impact of the heat radiation of the surrounding hot elements, in the direction of the assembly integrated to the receiver according to the invention.

Preferably, the receiver further comprises a mechanical transmission device forming a reduction gear and comprising a planetary gear set, said device being supplied with lubricant by said lubricant circulation pipe.

Preferably, the receiver further comprises at least one lubricated enclosure housing at least one roller bearing, said enclosure being supplied with lubricant by said lubricant circulation pipe.

Preferably, the receiver comprises a plurality of assemblies such as the one described hereinabove, distributed in different arms of said casing. Several arms, and even all of them are therefore provided with at least one such assembly, and several of these assemblies can pass through the same arm. It is also possible for the same hydraulic pipe for controlling an actuator to be connected by thermal bridges to different lubricant pipes, without leaving the scope of the invention.

More preferably, the receiver is a system of contra-rotating propellers, and more preferably a contra-rotating propeller dipole.

Finally, the invention relates to an aircraft turbomachine comprising a receiver such as described hereinabove, more preferably located downstream of a gas generator of this turbomachine.

Other advantages and characteristics of the invention shall appear in the detailed and non-restricted description hereinbelow.

### BRIEF DESCRIPTION OF THE DRAWINGS

This description shall be made with respect to the annexed drawings among which;

FIG. 1 shows a refined view as a longitudinal cross-section of a turbomachine of the “open rotor” type, intended to integrate a receiver according to the invention;

FIG. 2 is a cross-section view taken along the line II-II of FIG. 1;

FIG. 3 is a more detailed cross-section view of a portion of the receiver of the turbomachine shown in FIG. 1;

FIG. 4 is a partial cross-section view of an assembly according to a preferred embodiment of the invention, integrated to the receiver of the turbomachine shown in the preceding figures; and

FIG. 5 is a perspective view of the assembly shown in FIG. 4.

### DETAILED DESCRIPTION OF PREFERRED EMBODIMENTS

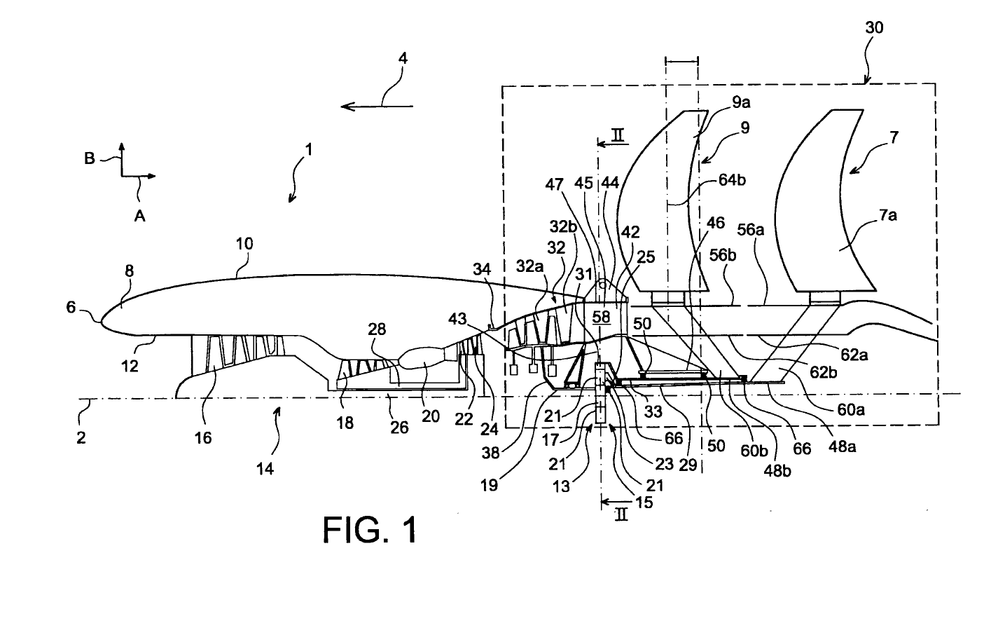

In reference to FIG. 1, a turbomachine 1 of the “open rotor” type can be seen, intended to integrate a receiver according to the invention. In this figure, certain elements of the turbomachine have voluntarily been omitted for reasons of clarity.

The direction A corresponds to the longitudinal direction or axial direction, parallel to the longitudinal axis 2 of the turbomachine. The direction B corresponds to the radial direction of the turbomachine. In addition, the arrow 4 diagrammatically shows the forward direction of the aircraft under the action of the thrust of the turbomachine 1, with this forward direction being contrary to the main direction of the flow of gases within the turbomachine. The terms “front” and “downstream” used in the rest of the description are to be considered in relation to this forward direction 4.

In the front portion, the turbomachine has an air inlet 6 that continues towards the rear via a nacelle 8, with the latter comprising globally an outer skin 10 and an inner skin 12, both centred on the axis 2 and radially offset from one another.

The inner skin 12 forms an outer radial casing for a gas generator 14, conventionally comprising, from the front towards the rear, a low-pressure compressor 16, a high-pressure compressor 18, a combustion chamber 20, a high-pressure turbine 22, and an intermediate-pressure turbine 24. The compressor 16 and the turbine 24 are mechanically linked by a shaft 26, forming as such a low-pressure body, while the compressor 18 and the turbine 22 are mechanically connected by a shaft 28, forming a body with a higher pressure. Consequently, the gas generator 14 more preferably has a conventional design, referred to as twin-spool.

Downstream of the intermediate-pressure turbine 24, there is a receiver 30 of the turbomachine, with this receiver forming a system of contra-rotating propellers, and more precisely a contra-rotating propeller dipole.

The receiver 30 comprises a free power turbine 32, forming a low-pressure turbine and is located just to the rear of the gas generator 14. It comprises a rotor 32a constituting the internal portion of the turbine, as well as a stator 32b constituting the external portion of this turbine, which is solidly connected to a fixed casing assembly 34 of this propeller system, centred on the longitudinal axis 2 of the system. This stator 34 is of a known manner intended to be made integral with the other casings of the turbomachine. As mentioned hereinabove, it is indicated that the receiver 30 is designed in such a way that the propellers are devoid of the external radial fairing surrounding them, as can be seen in FIG. 1.

In addition, downstream of the contra-rotating turbine 32, the receiver 30 integrates a first propeller 7 or downstream propeller, bearing blades 7a. In an analogous manner, the system 30 comprises a second propeller 9 or upstream propeller, bearing blades 9a. As such, the propellers 7, 9 are offset from one another according to the direction 4, and both of them are located downstream of the free turbine 32.

The two propellers 7, 9 are intended to rotate in opposite directions about the axis 2 whereon they are centred, with the rotations carried out in relation to stator 34 remaining immobile.

For the driving in rotation of these two propellers 7, 9, a mechanical transmission device 13 is provided, forming a reduction gear and comprising in particular a planetary gear set 15.

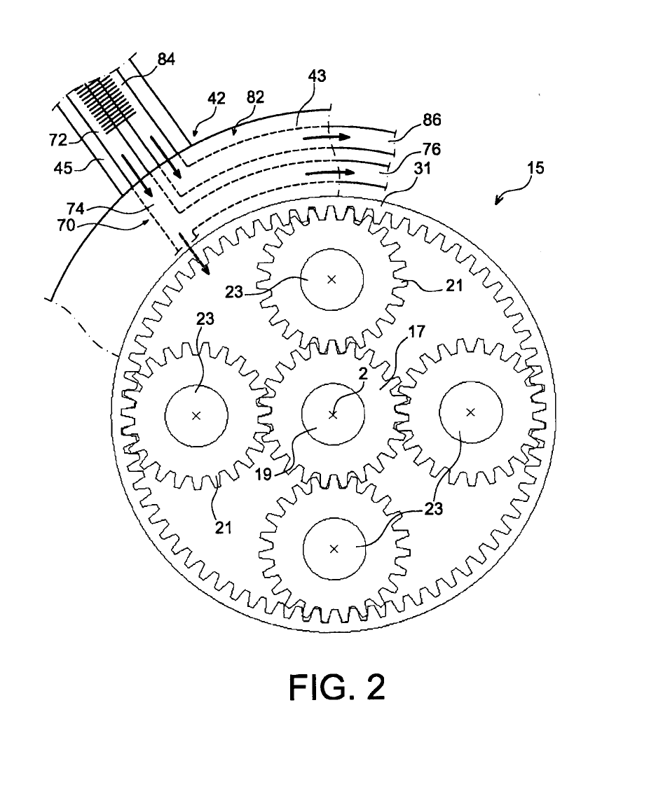

In reference to FIGS. 1 and 2, the train 15 is provided with a sun gear 17 centred on the longitudinal axis 2, and borne by a planetary shaft 19 of the same axis, solidly connected upstream to the rotor 32a, through a flange 38. As such, the rotor 32a directly drives the sun gear 17 in rotation, with the latter taking the form of an exteriorly toothed wheel.

The train 15 also comprises a satellite 21, and more preferably several as can be seen in FIG. 2, with each of them meshing with the sun gear 17. Each satellite 21 is borne by a satellite shaft 23 with an off-centred axis in relation to the axis 2, and takes the form of an exteriorly toothed wheel.

Furthermore, the train 15 is provided with a planet carrier 25 centred on the longitudinal axis 2, and bearing rotatingly each of the satellites 21, by the intermediary of the shafts 23, respectively. The planet carrier 25 is borne by a planet carrier shaft 29 of the same axis, integral with the first propeller 7, as can be seen in FIG. 1, in such a way as to be able to directly drive it in rotation.

Finally, the train 15 has a crown 31 centred on the axis 2 and borne by a crown shaft 33 of the same axis, with this crown 31 meshing with each satellite 21. The shaft 33 extends in a downstream direction by being integral with the second propeller 9, in such a way as to be able to drive it directly in rotation. For example, this shaft 33 is located around the planer carrier shaft 29 with which it is concentric. The crown 31 takes the form of an interiorly toothed wheel.

The planetary gear set 15 is located to the right and inside a casing 42 interposed between the free power turbine 32 and the propellers 7, 9. This casing 42, also referred to as exhaust casing or “static frame”, bears an engine fastener 44 intended to provide the fastening of the turbomachine on the structure of the aircraft. Generally, it is indicated that the mechanical transmission device is housed in the hub 43 of the casing 42, with the latter also comprising an outer ferrule 47 connected to the hub by radial arms 45. The outer ferrule 47 is located in the rear continuity of the envelope of the stator 32b.

The casing 42, downstream of which the propellers are located and upstream of which the power turbine 32 is located, comprises a casing extension 46 extending in the downstream direction in relation to a central portion of this casing. This extension 46 takes the form of a hollow cylinder centred on the axis 2, supporting in rotation a hub 48b of the second propeller, with this hub 48b being confounded with the crown shaft 33, as can be seen in FIG. 1. This support in rotation is carried out by the intermediary of two roller bearings 50 spaced apart one from the other according to the direction A, and interposed between the extension 46 and the hub 48b.

The second propeller 9 also comprises an outer ferrule 56b arranged concentrically to the hub 48b, and participating in the radial delimitation outwards of a main annular flow stream 58, with this flow stream also being delimited between the hub 43 and the outer ferrule 47 on exhaust casing 42.

In addition, it also comprises a plurality of connecting arms 60b connecting the outer ferrule 56b au hub 48b. The connecting arms 60b bear a second intermediate ferrule 62b arranged between the hub 48b and the outer ferrule 56b, with this ferrule 62b participating in the radial delimitation inwards of the main annular flow stream 58.

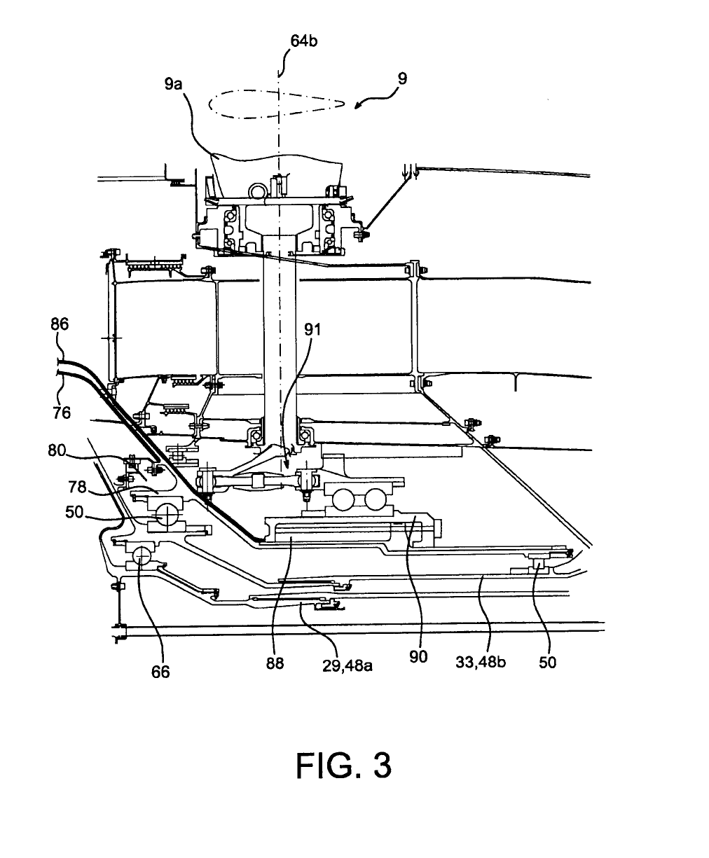

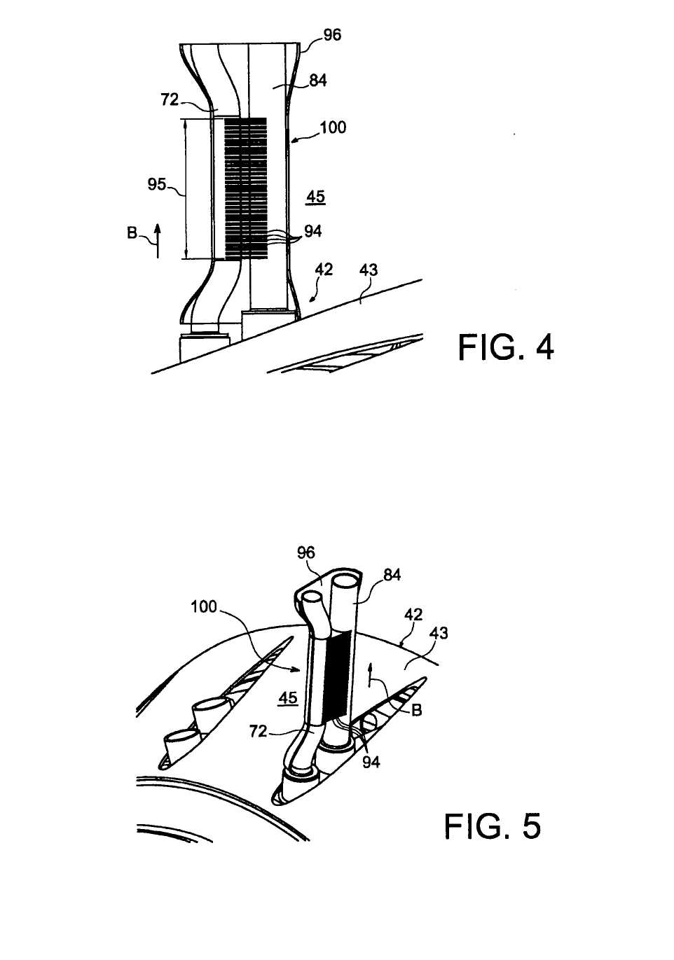

Furthermore, as shown in FIG. 1 and as shall be in more detail in reference to FIG. 3, each blade 9a is mounted in such a way as to be able to be controlled/set in pitch about its pivoting axis 64b, by its variable pitch system (not shown in FIG. 1).

The crown shaft 33 takes the form of a hollow cylinder centred on the axis 2, supporting in rotation a hub 48a of the first propeller, with this hub 48a being confounded with the planet carrier shaft 29, as can be seen in FIG. 1. This support in rotation is carried out by the intermediary of two roller bearings 66 spaced apart one from the other according to the direction A, and interposed between the two hubs 48b, 48a.

The first propeller 7 also comprises an outer ferrule 56a arranged concentrically to the hub 48a, and participant in the radial delimitation outwards of the main annular flow stream 58. It is located in the downstream aerodynamic extension of the outer ferrule 56b of the second propeller.

In addition, it also comprises a plurality of connecting arms 60a connecting the outer ferrule 56a to the hub 48a. Furthermore, the connecting arms 60a of the first propeller bear a first intermediate ferrule 62a arranged between the hub 48a and the outer ferrule 56a, with this ferrule 62a also participating in the radial delimitation inwards of the main annular flow stream 58. It is located in the downstream aerodynamic extension of the intermediate ferrule 62b of the second propeller.

In reference now more specifically to FIG. 2, it is shown that the receiver comprises a lubrication circuit 70 intended to supply the transmission device with lubricant, and more particularly its epicyclic train 15. To do this, a lubricant circulation pipe 72, more preferably of oil, passes through one of the arms 45 of the exhaust casing 42. This pipe 72 thus travels radially through one of the arms 45, over the entire length of the latter, in order to circulate the cool lubricant coming radially from the outside of the casing 42 in the direction of the elements to be cooled. In particular, the pipe 72 is connected to a downstream portion of the circuit 70 supplying on the one hand the train 15 in order to cool it, via the section referenced as 74, and supplying on the other hand one or several roller bearing enclosures, via another section 76. The two sections/conduits 74, 76 travel through the hub 42 before joining other elements of the circuit 70, such as shall be explained hereinafter.

In reference to FIG. 3, it is shown an embodiment wherein the conduit 76 travels downstream along a static portion 78 borne by the exhaust casing, with this conduit 76 opening in a known manner into a lubricated enclosure 80 wherein is located one of the roller bearings 50 to be cooled. Other lubricated enclosures can be supplied in a similar manner, without leaving the scope of the invention.

The lubricant therefore flows continuously in the circuit 70 through the train 15 and the enclosure 80, by being re-circulated in order to again be conveyed upstream of the pipe 72 passing through the arm of the exhaust casing.

Moreover, returning to FIG. 2, it is shown that the receiver comprises a hydraulic circuit 82 intended for controlling an actuator for changing the pitch of the blades of the propeller. To do this, a hydraulic pipe 84 passes through the same arm 45 as the one that the lubricant pipe 72 passes through. This pipe 84 therefore travels radially through this arm 45, over the entire length of the latter, being filled with a fluid, more preferably with oil, for controlling the actuator which shall be mentioned hereinafter. The pipe 84 is as such connected to a downstream portion of the circuit 82 supplying the control actuator, via the section referenced as 86 travelling through the hub 42, before joining the actuator 88 as is shown in FIG. 3.

Indeed, the conduit 86 travels in a downstream direction along the static portion 78, with this conduit 86 opening in a known manner in the annular chamber of the actuator 88 defined interiorly by this same static portion 78. In this respect, it is noted that the annular piston 90 of the actuator 88 is mechanically connected in a manner known per se to a system 91 for the pitch of the blades 9a, with the modification in the axial position of this piston 90 driving a rotation of the blades 9a about their axes 64b, and as such modifying the pitch of these blades.

The two pipes 72, 84 therefore travel side-by-side over at least a portion of the length of the arm 45 that they are passing through, with the two adjacent portions being more preferably parallel, and not very far away from one another. One of the particularities of this invention resides in the fact of providing means forming a thermal bridge between the two pipes 72, 84, in order to result in an original heat exchange—that makes it possible to evacuate the heat that builds up in the relatively static hydraulic pipe 84. The means forming a thermal bridge arranged between the two pipes serve in effect to transfer the heat from one pipe to the other, with this heat then being evacuated by the lubricant usually flowing with a substantial flow rate in its pipe 72, contrary to the fluid of the hydraulic pipe 84 for controlling an actuator which is relatively static.

The means forming a thermal bridge here take the form of a plurality of strips 94 each having two ends respectively connected to the two pipes 72, 84, more preferably by welding. The strips 94 are more preferably made of copper or in one of its alloys, in order to improve the effect of the thermal transfer in the direction of the lubricant pipe 72 through which the heat is dissipated. The strips 94 are spaced apart from one another according to the radial direction B to which they are preferentially orthogonal, and are more preferably parallel to each other. They can be several tens in number. More preferably, the group of strips 94 extends along pipes 72, 84 in a space of which the radial length 95 corresponds more preferably to the total radial length of the associated arm 45, possibly subtracted from the lengths required for setting up fittings located at the ends.

In the preferred embodiment which is described and represented, with the assembly 100 comprising the two pipes 72, 84 connected by the strips 9 further comprises a thermal protection sheath 96 covering at least the assembly formed by these strips 94 and the portions of the pipes 72, 84 connected by the strips. Here, the sheath 96 being over substantially the entire length of the arm 45 that it passes through. It is more preferably thermally insulated in order to make it possible to limit the impact of the heat radiation of the casing arms, in the direction of the pipes 72, 84 the assembly 100.

It is noted that several assemblies 100 can be provided in the same arm 45 exhaust casing, whether or not sharing the same sheath 96. In addition, several of the arms 45 are equipped with at least one such assembly.

Of course, various modifications can be made by those skilled in the art to the invention which has just been described, solely by way of unrestricted examples.

1-10. (canceled)

11. A receiver of an aircraft turbomachine, comprising:
at least one propeller comprising blades;
an actuator for changing a pitch of the blades of the propeller;
a casing, or an exhaust casing, including a hub and an outer ferrule connected by arms and defining between them a flow stream of the gases; and
at least one assembly arranged in one of the arms of the casing, the assembly including a lubricant circulation pipe and a hydraulic pipe for controlling the actuator for changing the pitch of the blades of the propeller,
wherein the assembly includes, in the arm of the casing, means forming a thermal bridge between the lubricant circulation pipe and the hydraulic pipe.

12. The receiver according to claim 11, wherein the means forming a thermal bridge includes a plurality of strips each including two ends respectively connected to the lubricant circulation pipe and to the hydraulic pipe.

13. The receiver according to claim 11, wherein the means forming a thermal bridge is made from copper or from one of its alloys.

14. The receiver as claimed in claim 11, further comprising a thermal protection sheath covering the assembly formed by the means forming a thermal bridge and portions of the pipes connected by these same means.

15. The receiver as claimed in claim 11, wherein the lubricant circulation pipe and the hydraulic pipe travel side-by-side over at least a portion of a length of the arm that they pass through.

16. The receiver as claimed in claim 11, further comprising a mechanical transmission device forming a reduction gear and comprising a planetary gear set, the device being supplied with lubricant by the lubricant circulation pipe.

17. The receiver as claimed in claim 11, further comprising at least one lubricated enclosure housing at least one roller bearing, the enclosure being supplied with lubricant by the lubricant circulation pipe.

18. The receiver as claimed in claim 11, further comprising a plurality of assemblies distributed in different arms of the casing.

19. The receiver as claimed in claim 11, as a system of contra-rotating propellers.

20. A turbomachine for an aircraft comprising a receiver as claimed in claim 11, or located downstream of a gas generator of the turbomachine.
